(19) United States
(12) Patent Application Publication
(10) Pub. No.: US 2014/0208407 A1
(43) Pub. Date: Jul. 24, 2014

(54) SINGLE SIGN-ON BETWEEN DEVICE APPLICATION AND BROWSER

(71) Applicant: LENOVO (SINGAPORE) PTE. LTD., Singpaore (SG)

(72) Inventors: Russell Speight VanBlon, Raleigh, NC (US); Jeffrey Mark Estroff, Cary, NC (US); Jefferson Logan Holt, Rolesville, NC (US)

(73) Assignee: Lenovo (Singapore) Pte. Ltd., Singpaore (SG)

(21) Appl. No.: 13/745,784

(22) Filed: Jan. 19, 2013

(51) Int. Cl. G06F 21/41

(52) U.S. Cl. CPC G06F 21/41
USPC 726/8

(57) ABSTRACT

An aspect provides a method, including: receiving user credentials at a client application via an input device of an information handling device; creating a token using the user credentials; launching a web browser after receiving input at the client application; providing the token to a remote device; and loading, in response to the remote device authenticating the user based on the token, a secure web site in the web browser for presentation on a display device associated with the information handling device. Other aspects are described and claimed.

### BACKGROUND

Information handling devices (“devices”) come in a variety of forms, for example desktop and laptop computing devices, tablet computing devices, smart phones, e-readers, MP3 players, and the like. Many such devices are configured for use with applications “apps”, which often are downloaded by a user to his or her device (“client device”). Often times, these apps have a web-based presence, e.g., a web site that offers products and services associated with the client application.

As an example, a music store app may be downloaded to a client device by a user and provide the user with the ability to buy and download music files from the music store app at the client device. However, often such applications will include offers for products or services that are only available from the web-based presence (e.g., a product that may only be purchased using an associated music store web site in this example). Thus, a user may locate a product or service using the client device app and then (e.g., after selecting the product or service link within the client application) be automatically redirected to the web-based presence. In a common example, this re-direction takes the form of launching a web browser that takes the user to the associated web site corresponding to the selected product or service located using the app on the client device. Once at the web site, the user may complete the purchase or access the service desired, etc.

### BRIEF SUMMARY

In summary, one aspect provides a method, comprising: receiving user credentials at a client application via an input device of an information handling device; creating a token using the user credentials; launching a web browser after receiving input at the client application; providing the token to a remote device; and loading, in response to the remote device authenticating the user based on the token, a secure web site in the web browser for presentation on a display device associated with the information handling device.

Another aspect provides an information handling device, comprising: an input device; one or more processors; and a memory operatively coupled to the one or more processors that stores instructions executable by the one or more processors to perform acts comprising: receiving user credentials at a client application via an input device of the information handling device; creating a token using the user credentials; launching a web browser after receiving input at the client application; providing the token to a remote device; and loading, in response to the remote device authenticating the user based on the token, a secure web site in the web browser for presentation on a display device associated with the information handling device.

A further aspect provides a program product, comprising: a storage medium having computer program code embodied therewith, the computer program code comprising: computer program code configured to receive user credentials at a client application via an input device of an information handling device; computer program code configured to create a token using the user credentials; computer program code configured to launch a web browser after receiving input at the client application; computer program code configured to provide the token to a remote device; and computer program code configured to load, in response to the remote device authenticating the user based on the token, a secure web site in the web browser for presentation on a display device associated with the information handling device.

A still further aspect provides a method, comprising: receiving, at an information handling device, user credentials input at a client application of a client device, the credentials received in the form of a token derived from the user credentials; authenticating, in response to a web page request from the client device, the user based on the token; providing, in response to authenticating the user based on the token, a secure web site to the web browser of the client device for presentation on a display device associated with the client device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device and components thereof

FIG. 2 illustrates another example information handling device and components thereof

FIG. 3 illustrates an example method of providing a single sign-on between device application and a browser.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In this description, client application (or client side application, client app or the like) takes the meaning of an application resident on a client device (e.g., tablet, smart phone, or other personal information handling device). A token takes the meaning of information identifying a user's session, e.g., a text based string. Each token is unique per login session. A token may be validated based on settings on the device performing the authentication (e.g., the web server in question).

Authentication problems exist between client side applications (“client apps”) and their associated web sites. For example, when a user authenticates in a client app on a client device (e.g., tablet computer) and then selects a product or service that is only available via an associated web site, the client app launches a web browser addressed to an appropriate web site (e.g., for completing a transaction).

However, even though the web site may use the same user credentials, the user is not recognized by the web site. This is so even though the user may have already authenticated to the client app and the web site uses the same credentials. The user in turn is required to input his or her credentials to authenticate to the web site, but this requires inputting the credentials a second time (e.g., user name/password input). While certain operating systems (e.g., WINDOWS 8 operating system) supports SSO between certain applications (e.g., “METRO applications” in the case of WINDOWS 8 operating system), there is no method to support SSO between an application and a web browser.

Accordingly, embodiments provide methods, products and devices that permit a single sign on (“SSO”) to be performed using a client app and a web site such that the user need only authenticate a single time (e.g., to the client side app). Embodiments therefore greatly reduce the cumbersome credentialing process that a user currently encounters when attempting to access products or services via a client app and associated web site.

The illustrated example embodiments will be best understood by reference to the figures. The following description is intended only by way of example, and simply illustrates certain example embodiments.

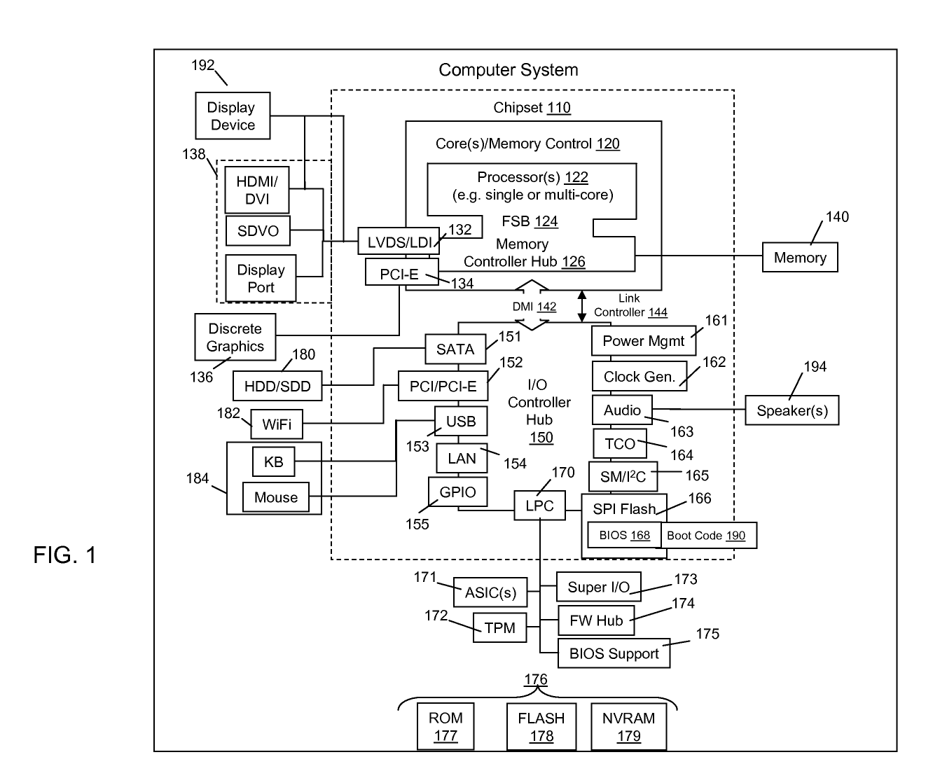

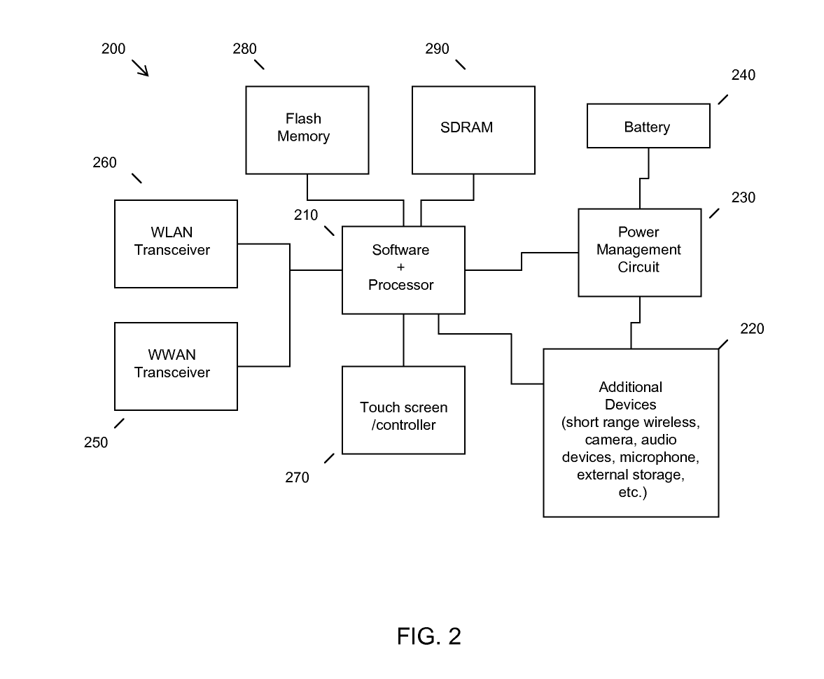

Referring to FIG. 1 and FIG. 2, while various other circuits, circuitry or components may be utilized, with regard to smart phone and/or tablet circuitry 200, an example illustrated in FIG. 2 includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, which may be used in connection with managing battery cells, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may include various client apps, including client apps downloaded by a user and a web browsing application. As described herein, the client apps may include a functionality wherein the client app causes a web browser to be launched in response to various user inputs, e.g., a user selecting a product or service that requires interaction/input with an associated web site.

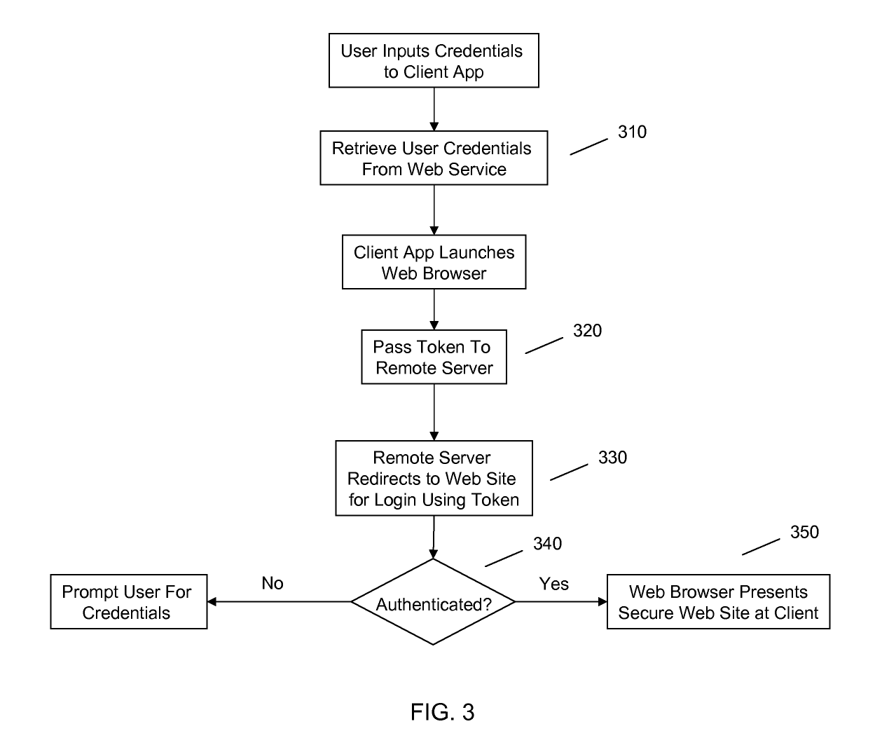

Referring to FIG. 3, an example of SSO credentialing according an embodiment is illustrated. An embodiment facilitates a SSO credentialing process for client app and web browser use. As outlined in FIG. 3, at 310 an embodiment provides an application that takes a user's credentials (e.g., user name/password) and obtains a token after the user logs into the client side app. The token may be obtained in a variety of ways. For example, a token may be retrieved from a web service running on the client device or generated by an application of the client device. At 320, when a client app launches the web browser in response to a user input (e.g., selection of a product or service that requires an associated web site session), the application passes the token (which may be validated, as further described herein) and the destination URL to a remote server to log the user into the remote server. This may be repeated for any remote server (e.g., web server) to supply it with the same user credentials.

At 330, on the server side, when the remote server (e.g., web server) receives the token, it provides the user with the desired web site using the token. For example, the remote server may set the token in the browser and redirect the browser to the target URL that recognizes the user (automatically) using the supplied token. If the token set in the browser is not accepted and the user is not authenticated at 340 (e.g., incorrect user credentials, token not valid, etc.) the user may be prompted for input of credentials to the web site (per standard convention). If the token is accepted, at 350 the web browser may thus present a web site that requires user login (“secure web site”) via use of the token. The token may be passed to the remote server via query string, form data, etc. Accordingly, an embodiment provides a mechanism whereby the user has input his or her credentials a single time (e.g., to the client app) and both the client app and the web browser recognize the user, eliminating the need for the user to provide his or her credentials to the web site for authentication.

Various security measures may be implemented to protect the process from unwanted or unauthorized access. For example, if it has been long enough (in time) since the user has input the credentials to the client app, the token may no longer be valid (e.g., a time out). The client app may also request that the user re-authenticate (i.e., re-input his or her credentials to the client app) prior to launching the web browser (e.g., after a time out has taken place or as a default measure for certain applications or functions thereof, e.g., payment web sites may be the focus of more security, etc.).

An embodiment thus provides for the routing of a device-based application user (“client app”, A₁), authenticated through an SSO provider, to a browser-based application (“web browser”, A₂), and communicating the user's authentication state from (A₁) to (A₂).

With further reference to FIG. 3, as an example for accomplishing this routing, a proxy server exists between the client device and resident client app and the web-based application target, i.e. the web site. The proxy server may verify the request for the web site before completing the steps necessary for securely communicating the user's authentication state (token). The verification process performs steps that guarantee that:
a) the requestor is authorized to make the request;
b) the token being passed was created by an authorized service for the requestor;
c) the token begin passed is valid; and
d) the target URL is valid

Items that may be used to accomplish these steps (a-d) include making decisions based on the requestor's IP address, which is available to logic on the proxy server, as well as token state and origination log files managed by the SSO provider. One or more of these, or other, security measures may be implemented to promote security to the process of passing the token and automatically authenticating the user to the web site using the token.

In practical use, a user may log into a client app, for example a support application, resident on the user's client device (e.g., tablet or smart phone). The user is authenticated within the client app and thus may proceed to user certain features, e.g., search help information organized based on a user history associated with the credentials, i.e., as available within the client app. The user may further choose to view information only available on an associated web site, e.g., user forums in which users may post comments and questions. On selecting such a service (e.g., via clicking on a link within the client app), the client app launches a web browser, as is known. According to an embodiment, however, a token is provided (e.g., to the web browser) automatically which may be used to authenticate the user to the web site having the requested product or service, (i.e., the “secure web site”). Thus, the user does not have to log in to the web site to access the requested service (e.g., posting comments or questions in a user forum).

The session token (including the user client app credentials) may be provided to the web site in a variety of ways. For example, the session token may be supplied to the web browser as a text string that is appended to the URL supplied to the web browser. The web server will thus be provided with the session token (and credentials) necessary for logging the user into the web site automatically. Other arrangements may also be utilized such that the client app credentials (token) are appropriately provided (formatted) for receipt and utilization by the web server.

Accordingly, embodiments provide methods, products and devices that permit a user to leverage a SSO between a client app and a web browser. This permits the user to quickly and conveniently sign into web sites associated with client apps without the need to re-input user credentials.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the functions/acts specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving user credentials at a client application via an input device of an information handling device;
creating a token using the user credentials;
launching a web browser after receiving a user selection at the client application;
providing the token to a remote device; and
loading, in response to the remote device authenticating the user based on the token, a secure web site in the web browser for presentation on a display device associated with the information handling device.

2. The method of claim 1, wherein the step of providing the token to a remote device comprises using the web browser to provide the token to the remote device.

3. The method of claim 2, wherein the token is provided to the web browser as a text string.

4. The method of claim 1, further comprising retrieving the token from a web service resident on the information handling device prior to providing the token to the remote device.

5. The method of claim 1, further comprising validating the token prior to providing the token to the remote device.

6. The method of claim 5, further comprising, responsive to determining the token is not valid, prompting the user for input of the user credentials.

7. The method of claim 6, wherein the user is prompted to input the user credentials to the client application.

8. The method of claim 1, wherein the step of loading a secure web site in the web browser for presentation on a display device associated with the information handling device further comprises loading a re-directed web site received from the remote device.

9. The method of claim 1, wherein the client application and the secure web site have been previously associated.

10. An information handling device, comprising:
an input device;
one or more processors; and
a memory operatively coupled to the one or more processors that stores instructions executable by the one or more processors to perform acts comprising:
receiving user credentials at a client application via an input device of the information handling device;
creating a token using the user credentials;
launching a web browser after receiving a user selection at the client application;
providing the token to a remote device; and
loading, in response to the remote device authenticating the user based on the token, a secure web site in the web browser for presentation on a display device associated with the information handling device.

11. The information handling device of claim 10, wherein the step of providing the token to a remote device comprises using the web browser to provide the token to the remote device.

12. The information handling device of claim 11, wherein the token is provided to the web browser as a text string.

13. The information handling device of claim 10, wherein the acts further comprise retrieving the token from a web service resident on the information handling device prior to providing the token to the remote device.

14. The information handling device of claim 10, wherein the acts further comprise validating the token prior to providing the token to the remote device.

15. The information handling device of claim 14, wherein the acts further comprise, responsive to determining the token is not valid, prompting the user for input of the user credentials.

16. The information handling device of claim 15, wherein the user is prompted to input the user credentials to the client application.

17. The information handling device of claim 10, wherein:
the remote device comprises a web server; and
wherein the step of loading a secure web site in the web browser for presentation on a display device associated with the information handling device further comprises loading a re-directed web site received from the web server.

18. The information handling device of claim 10, wherein the client application and the secure web site have been previously associated.

19. A program product, comprising:
a computer readable storage device having computer program code embodied therewith, the computer program code comprising:
computer program code configured to receive user credentials at a client application via an input device of an information handling device;
computer program code configured to create a token using the user credentials;
computer program code configured to launch a web browser after receiving a user selection at the client application;
computer program code configured to provide the token to a remote device; and
computer program code configured to load, in response to the remote device authenticating the user based on the token, a secure web site in the web browser for presentation on a display device associated with the information handling device.

20. A method, comprising:
receiving, at an information handling device, user credentials input by a user at a client application of a client device, the credentials received in the form of a token derived from the user credentials;
authenticating, in response to a web page request from the client device, the user based on the token;
providing, in response to authenticating the user based on the token, a secure web site to the web browser of the client device for presentation on a display device associated with the client device.

21. The method of claim 20, wherein the step providing a secure web site to the web browser of the client device for presentation on a display device associated with the client device further comprises providing a re-directed web site from the information handling device.
